(19) United States
(12) Patent Application Publication
(10) Pub. No.: US 2026/0030826 A1
(43) Pub. Date: Jan. 29, 2026

(54) DEVICE PREDICTING 3D STRUCTURE USING MULTIPLE SIGNALS AND METHOD OF OPERATING THE SAME

(71) Applicant: SAMSUNG ELECTRONICS CO., LTD., Suwon-si (KR)

(72) Inventors: Ami Ma, Suwon-si (KR); QHwan Kim, Suwon-si (KR); Jaeyong Lee, Suwon-si (KR); Kyu-Baik Chang, Suwon-si (KR); Jaehoon Jeong, Suwon-si (KR); Wanju Cho, Suwon-si (KR); Hyunsuk Choi, Suwon-si (KR); Suk-Ju Kang, Seoul (KR); Minsuh Song, Seoul (KR); Yeieun Hwang, Seoul (KR)

(73) Assignee: Sogang University Research & Business Development Foundation, Seoul (KR)

(21) Appl. No.: 19/200,346

(22) Filed: May 6, 2025

(30) Foreign Application Priority Data
Jul. 24, 2024 (KR) 10-2024-0098171
Oct. 22, 2024 (KR) 10-2024-0145056

(51) Int. Cl. G06T 15/00; G06T 5/70; G06T 7/50; G06V 10/44; G06V 10/771

(52) U.S. Cl. CPC G06T 15/00; G06T 5/70; G06T 7/50; G06V 10/44; G06V 10/771

(57) ABSTRACT

An example three-dimensional (3D) structure prediction device includes a first encoder, a second encoder, and a feature vector generator. The first encoder generates a first feature map based on two-dimensional (2D) image data corresponding to a target object. The second encoder generates a second feature map based on spectrum data corresponding to the target object. The feature vector generator receives the first feature map and the second feature map, and output a feature vector corresponding to a 3D structure of the target object based on a deep machine learning model.

### CROSS-REFERENCE TO RELATED APPLICATIONS

This application claims priority under 35 U.S.C. § 119 to Korean Patent Application No. 10-2024-0098171 filed on Jul. 24, 2024, and Korean Patent Application No. 10-2024-0145056 filed on Oct. 22, 2024, in the Korean Intellectual Property Office, the disclosures of which are incorporated by reference herein in their entirety.

### BACKGROUND

Semiconductor chip processes are miniaturized to nanometer levels or more in response to the demand for miniaturization of semiconductor chips. Accordingly, to evaluate specific performance during a process, it is necessary to accurately identify a three-dimensional (3D) structure of various components used in the process.

A scanning electron microscope (SEM), which is used to identify the structure of an element during the semiconductor manufacturing process, may obtain surface information of a wafer based on various types of electrons generated by the interaction between an electron beam and the wafer by scanning the electron beam on the wafer. However, image data obtained through the SEM lacks depth information, thereby making it difficult to accurately predict the 3D structure of the wafer.

### SUMMARY

The present disclosure relates to a device for predicting 3D structure by using multiple signals and a method of operating the same.

In general, according to some aspects, a 3D structure prediction device includes a first encoder that generates a first feature map based on 2D image data corresponding to a target object, a second encoder that generates a second feature map based on spectrum data corresponding to the target object, and a feature vector generator that receives the first feature map and the second feature map and uses a deep learning model machine-learned to output a feature vector corresponding to a 3D structure of the target object.

In general, according to some aspects, a method of operating a 3D structure prediction device includes generating a first feature map based on 2D image data corresponding to a target object, generating a second feature map based on spectrum data corresponding to the target object, and receiving the first feature map and the second feature map and generating a feature vector by using a deep learning model machine-learned to output the feature vector corresponding to a 3D structure of the target object.

In general, according to some aspects, an electronic system that predicts a 3D structure of a target object includes a first sensor device that generates 2D image data by sensing the target object, a second sensor device that generates spectrum data by sensing the target object, and a 3D structure prediction device that generates 3D image data corresponding to the 3D structure of the target object based on the 2D image data and the spectrum data. The 3D structure prediction device includes a first encoder that generates a first feature map based on the 2D image data, a second encoder that generates a second feature map based on the spectrum data, and a feature vector generator that receives the first feature map and the second feature map and uses a deep learning model machine-learned to output a feature vector corresponding to the 3D structure of the target object.

### BRIEF DESCRIPTION OF THE DRAWINGS

The above and other objects and features of the present disclosure will become apparent by describing in detail implementations thereof with reference to the accompanying drawings.

FIG. 1 is a block diagram of an example of an electronic system.

FIG. 2 is a block diagram of an example of a 3D structure prediction device of FIG. 1.

FIG. 3 is a block diagram illustrating an example of an architecture related to the first encoder of FIG. 2.

FIG. 4 is a block diagram illustrating an example of an architecture related to the second encoder of FIG. 2.

FIG. 5 is a block diagram illustrating in detail an example of the second encoder of FIG. 2.

FIG. 6 is a block diagram illustrating in detail an example of the second encoder of FIG. 2.

FIG. 7 is a drawing for describing an example of a feature vector generator of FIG. 2.

FIG. 8 is a block diagram illustrating in detail an example of a decoder of FIG. 2.

FIG. 9 is a diagram for describing an example of a residual map based on a general depth map and a depth map generated.

FIG. 10 is a flowchart for sequentially describing an example of a method of operating a 3D structure prediction device of FIG. 2.

### DETAILED DESCRIPTION

Hereinafter, implementations of the present disclosure will be described in detail and clearly to such an extent that one skilled in the art easily carries out the present disclosure.

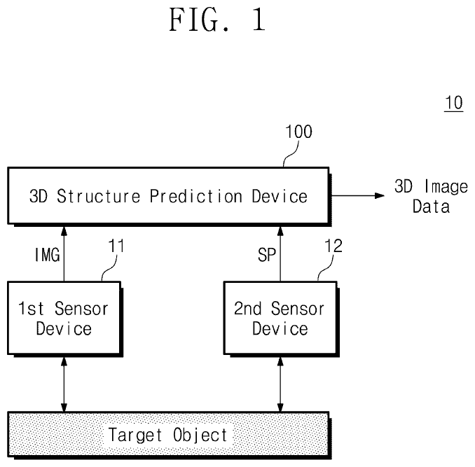

FIG. 1 is a block diagram of an example of an electronic system. Referring to FIG. 1, an electronic system 10 may include a first sensor device 11, a second sensor device 12, and a 3D structure prediction device 100.

The electronic system 10 may predict the structure of a target object by sensing various types of information about the target object. For example, the target object may be a wafer used in a semiconductor manufacturing process, and the electronic system 10 may predict the 3D structure of the target object and may provide 3D image data corresponding to the predicted 3D structure.

Each of the first sensor device 11 and the second sensor device 12 may generate sensing information by sensing the target object. For example, the sensing information may include 2D image data corresponding to the surface of the target object or information about the depth of the surface of the target object.

In some implementations, the first sensor device 11 may generate 2D image data IMG by sensing the target object. The 2D image data IMG may refer to image data, which corresponds to at least part of the surface of the target object and is displayed in two dimensions.

For example, the first sensor device 11 may be one of a SEM, an X-ray, an atomic force microscope (AFM), or a transmission electron microscope (TEM). Specifically, the SEM may generate information about the surface of the target object by injecting an e-beam into the target object and sensing secondary electrons or back-scattered electrons generated by the interaction between the target object and the electron beams. The first sensor device 11 may provide the 2D image data IMG to the 3D structure prediction device 100.

In some implementations, the second sensor device 12 may generate the spectrum data SP by sensing the target object. The spectrum data SP may refer to data expressed in a spectrum format corresponding to the depth (e.g., a distance from a reference plane parallel to the plane of a semiconductor wafer to the semiconductor wafer in a vertical direction) of the target object.

For example, the second sensor device 12 may obtain the spectrum data SP for the target object based on an optical critical dimension (OCD) measurement method. In detail, the OCD measurement method is a technology for reversely calculating a vertical profile of a pattern by applying the reflectivity and phase information of light, which is diffracted through the vertical patterns formed on the target object, to the electromagnetic theory. The second sensor device 12 may provide the spectrum data SP to the 3D structure prediction device 100.

However, the scope of the present disclosure is not limited thereto, and the number of sensors for sensing the target object may be two or more. In addition to the types of sensor devices described above, a sensor that generates data in the form of an image, spectrum, or the like capable of being used to predict a 3D structure may be used alternatively or additionally.

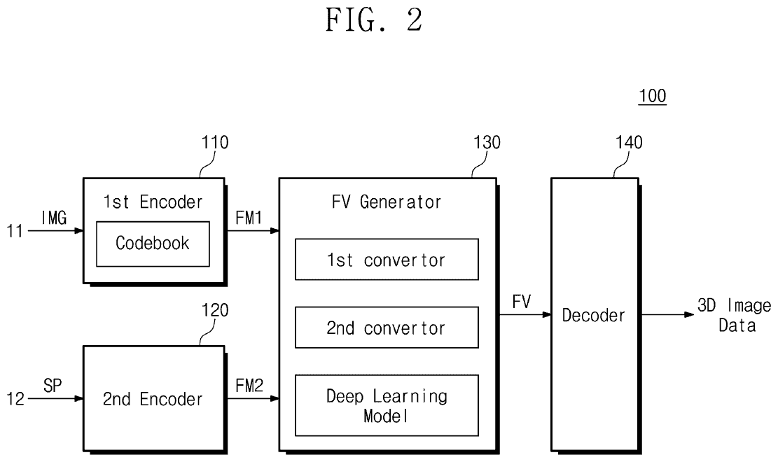

The 3D structure prediction device 100 may receive the 2D image data IMG and the spectrum data SP from the first sensor device 11 and the second sensor device 12, respectively. The 3D structure prediction device 100 may predict a 3D structure corresponding to the target object based on the 2D image data IMG and the spectrum data SP, and may generate 3D image data corresponding to the predicted 3D structure. Detailed descriptions thereof will be described later with reference to FIG. 2.

The 3D structure prediction device 100 may include at least one piece of hardware, at least one piece of software, at least one piece of firmware, or a combination of hardware and software.

In some implementations, the electronic system 10 may further include a display device. The display device may receive 3D image data from the 3D structure prediction device 100. The display device may display the 3D image data as the predicted 3D structure of the target object.

FIG. 2 is a block diagram of an example of the 3D structure prediction device 100 of FIG. 1. Referring to FIG. 2, the 3D structure prediction device 100 may include a first encoder 110, a second encoder 120, a feature vector generator 130, and a decoder 140.

The first encoder 110 may receive the 2D image data IMG from the first sensor device 11 of FIG. 1. The first encoder 110 may generate a first feature map FM1 based on the 2D image data IMG.

In some implementations, the first encoder 110 may embed the 2D image data IMG into the first feature map FM1 by using a codebook. In detail, the codebook may include a plurality of features and a plurality of indices respectively corresponding to the plurality of features.

In some implementations, the codebook may be obtained through a process in which a generative adversarial network (GAN) including a 2D convolution operation performs machine learning through a data set. The GAN may refer to a network that trains a data set through a process in which a generator and a discriminator compete with each other.

In other words, the first encoder 110 may be trained in a process in which the GAN performs machine learning.

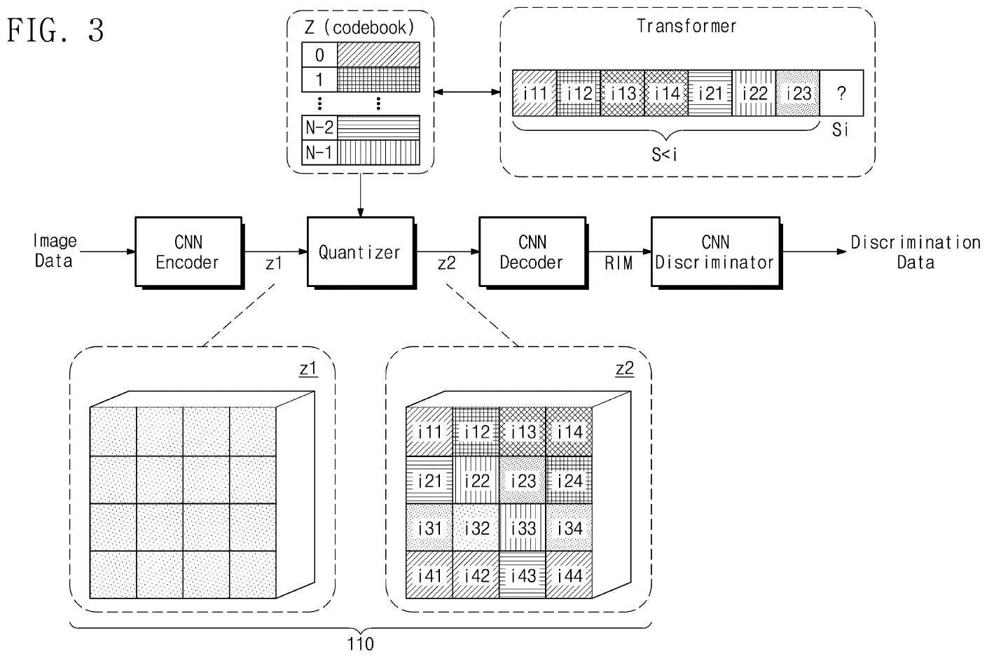

For example, the aforementioned GAN may be a vector quantized generative adversarial network (VQGAN), and in this case, the codebook may correspond to a codebook generated by the VQGAN. Detailed descriptions thereof will be described later with reference to FIG. 3.

The first encoder 110 may provide the first feature map FM1 to the feature vector generator 130.

The second encoder 120 may receive the spectrum data SP from the second sensor device 12 of FIG. 1. The second encoder 120 may generate a second feature map FM2 based on the spectrum data SP.

In some implementations, the second encoder 120 may embed the spectrum data SP into the second feature map FM2. In detail, the second encoder 120 may perform at least one convolution operation.

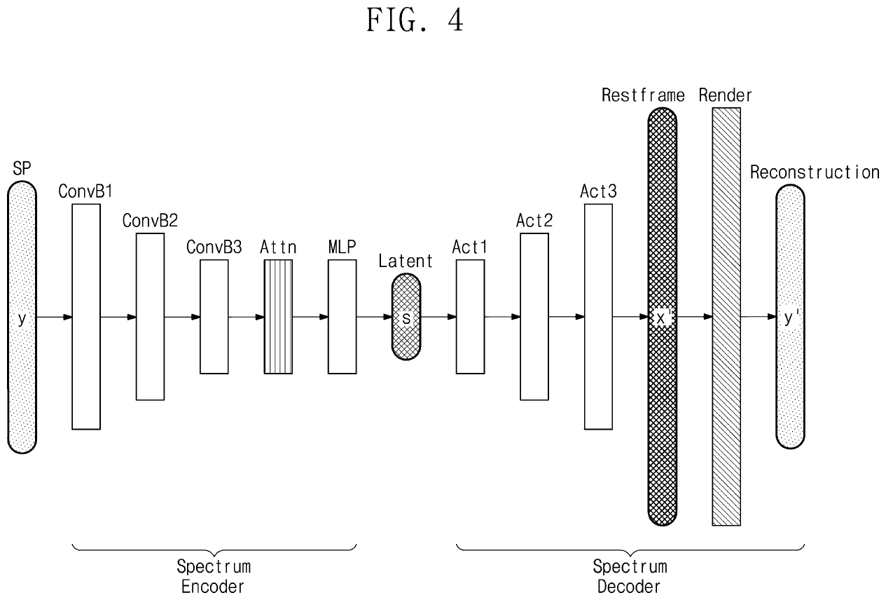

For example, the second encoder 120 may include at least one convolution operation of SPENDER architecture. The SPENDER architecture may refer to a neural network including an encoder that performs at least one one-dimensional (1D) convolution operation by using a spectrum data-enhanced algorithm. This will be more fully described with reference to FIGS. 4 to 6.

The second encoder 120 may provide the second feature map FM2 to the feature vector generator 130.

The feature vector generator 130 may receive the first feature map FM1 and the second feature map FM2 from the first encoder 110 and the second encoder 120, respectively. The feature vector generator 130 includes a first convertor and a second convertor, and may store a deep learning algorithm.

The deep learning algorithm may refer to an algorithm trained to receive the first feature map FM1 and the second feature map FM2 and to output a feature vector FV corresponding to the 3D structure of the target object.

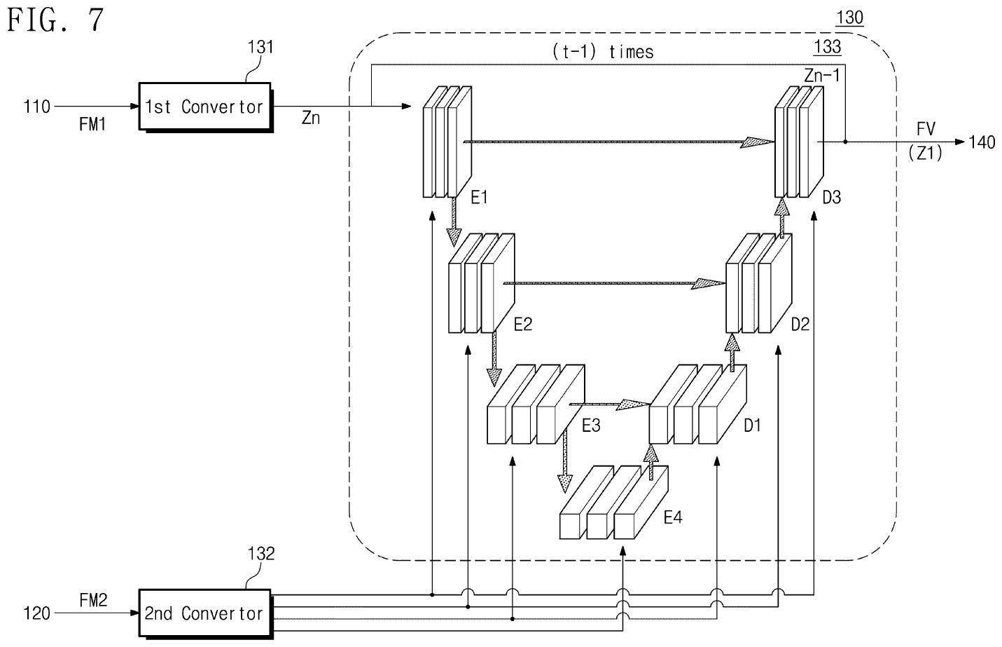

In some implementations, the deep learning algorithm may include a denoising algorithm. For example, the denoising algorithm may refer to an algorithm that gradually removes noise based on a convolution operation of image data including noise. Detailed descriptions thereof will be described later with reference to FIG. 7.

The first convertor may generate an image vector by using a diffusion algorithm on the first feature map FM1. For example, the diffusion algorithm may be a type of a deep learning algorithm. The image vector may be a vector corresponding to the 2D image of the target object, and may match the predetermined form of an input vector of the deep learning algorithm used by a feature vector generator.

In some implementations, the first convertor may generate an image vector by performing a convolution operation on the first feature map FM1.

The second convertor may generate a plurality of spectrum vectors by converting the size of the second feature map FM2.

In some implementations, the second convertor may generate a plurality of spectrum vectors by applying a multi-layer perceptron (MLP) algorithm to the second feature map FM2.

The feature vector generator 130 may generate the feature vector FV based on cross attention between an image vector and the plurality of spectrum vectors. Detailed descriptions thereof will be described later with reference to FIG. 7.

In some implementations, the feature vector generator 130 may use a denoising algorithm as a deep learning algorithm. For example, the feature vector generator 130 may use a denoising UNet that receives the image vector and outputs the feature vector FV.

The feature vector generator 130 may provide the feature vector FV to the decoder 140.

The decoder 140 may receive the feature vector FV from the feature vector generator 130. The decoder 140 may be configured to predict a 3D structure of the target object based on the feature vector FV and to generate 3D image data corresponding to the predicted 3D structure.

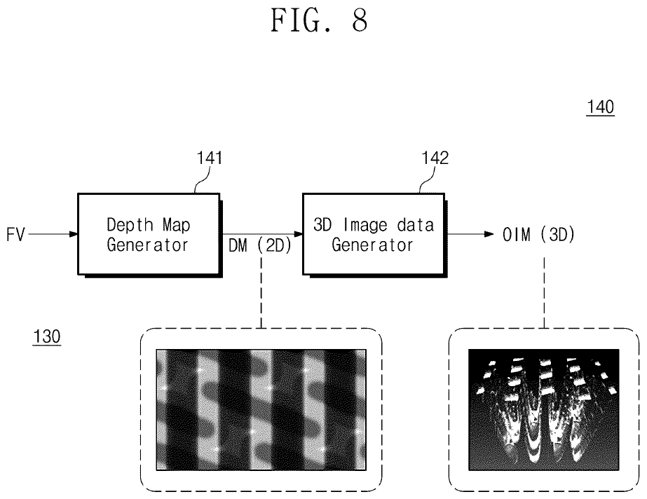

In some implementations, the decoder 140 may first generate a depth map by decoding the feature vector FV. The decoder 140 may predict the 3D structure based on the generated depth map. The decoder 140 may generate 3D image data corresponding to the predicted 3D structure. Detailed descriptions thereof will be described later with reference to FIG. 8.

FIG. 3 is a block diagram illustrating an example of an architecture related to the first encoder of FIG. 2. Referring to FIG. 3, a VQGAN architecture including a codebook ‘Z’ is illustrated.

The VQGAN architecture may be one of models that generate data by utilizing an autoencoder-based structure. In detail, the VQGAN architecture may be a model that generates high-resolution image data based on a convolution neural network (CNN) and a transformer algorithm.

For example, in a first step, the VQGAN architecture may train a local structure by building the codebook ‘Z’ of context-rich visual parts through the CNN. In other words, the VQGAN architecture may train each component of image data. Next, in a second step, the VQGAN architecture may train a global configuration that considers the relationship between visual parts through a transformer. In other words, the VQGAN architecture may train to construct the entire image data by synthesizing components of pieces of image data trained through the CNN. This will be described in detail below.

The VQGAN architecture may include a CNN encoder, a quantizer, a CNN decoder, and a CNN discriminator.

The CNN encoder may receive 2D image data and may generate first embedding vectors z1 based on the received 2D image data. In other words, the CNN encoder may compress image data in pixel space into latent space. Moreover, the CNN encoder may include at least one 2D convolution operation.

The quantizer may generate second embedding vectors z2 by performing vector quantization on the first embedding vectors z1 based on the codebook ‘Z’. The vector quantization may refer to mapping each category in a dictionary format. The codebook ‘Z’ may be a set of embedding vectors in embedding space.

In some implementations, the codebook ‘Z’ may include vectors expressed as a plurality of indices 0 to N−1 (′N′ is a natural number greater than or equal to 2) and components (expressed as different patterns in FIG. 3) of image data respectively corresponding to the plurality of indices.

In some implementations, the quantizer may calculate an Euclidean distance between the first embedding vectors z1 and the codebook ‘Z’, and may determine values of vectors having the smallest distance as the second embedding vectors z2.

For example, each of the second embedding vectors z2 may be represented as a single index. In detail, the second embedding vectors z2, which consist of 4×4, may be expressed as 16 indices i11 to i44. Each of the 16 indices i11 to i44 may correspond to one of the plurality of indices 0 to N−1 of the codebook ‘Z’.

The CNN decoder may generate reconstructed image data RIM by decoding the second embedding vectors z2. In other words, the CNN decoder may convert image data compressed in the latent space into image data in the pixel space.

The CNN discriminator may receive the reconstructed image data RIM from the CNN decoder. The CNN discriminator may generate discrimination data by determining whether it is real or fake in units of patch based on the reconstructed image data RIM.

In the first step, the VQGAN architecture may update at least one of the CNN encoder and the codebook ‘Z’ based on at least one loss. For example, the VQGAN architecture may consider a loss based on a difference between image data input to the CNN encoder and the reconstructed image data RIM.

After the codebook ‘Z’ is completely trained in the first step, in the second step, the transformer algorithm may use components (S<i), of which the order is smaller than ‘i’, in predicting the index of the i-th component Si. In this case, the transformer algorithm may be trained with negative log likelihood (NLL) by using the second embedding vector z2 in the first stage as a label value.

That is, at least part of the VQGAN architecture may be used as the first encoder 110 of FIG. 2. For example, the first encoder 110 may embed 2D image data by using a CNN encoder with the VQGAN architecture. The codebook of the first encoder 110 may correspond to the codebook ‘Z’ of the VQGAN architecture. Moreover, the first feature map FM1 output by the first encoder 110 may correspond to the second embedding vectors z2 of the VQGAN architecture.

FIG. 4 is a block diagram illustrating an example of an architecture related to the second encoder of FIG. 2. Referring to FIG. 4, a schematic diagram of the SPENDER architecture for analyzing spectrum data is illustrated.

The SPENDER architecture may be an autoencoder-based model and may be a model that analyzes the spectrum of light to detect the redshift of galaxies. The SPENDER architecture may include a spectrum encoder including a plurality of encoder layers and a spectrum decoder including a plurality of decoder layers.

The spectrum encoder may receive the spectrum data SP, may compress the spectrum data SP into low dimensions, and may generate a latent vector ‘S’. The spectrum encoder may generate reconstructed spectrum data, which has a wider spectrum range than the spectrum data SP and has higher resolution than the resolution of the spectrum data SP, based on the latent vector ‘S’.

The spectrum encoder may first pass the spectrum data SP through a plurality (e.g., three) of convolutional layers ConvB1 to ConvB3. Each of the convolutional layers ConvB1 to ConvB3 may include at least one 1D convolution operation. The spectrum encoder may select characteristic parts from spectrum data by passing the spectrum data, which is passed through the convolutional layers ConvB1 to ConvB3, through an attention layer Attn. Next, the spectrum encoder may pass the spectrum data through a MLP to perform redshift on the spectrum data to a galaxy stationary frame and may compress the spectrum data into a vector ‘S’ in the latent space.

The spectrum decoder may include a plurality (e.g., three) of activation layers Act1 to Act3. The spectrum decoder may generate the reconstructed rest frame x′ of the spectrum data by sequentially passing the low-dimensional latent vector ‘S’ through the activation layers Act1 to Act3. The spectrum decoder may perform redshift on the reconstructed rest frame x′ in a render layer and may generate reconstructed spectrum data y′.

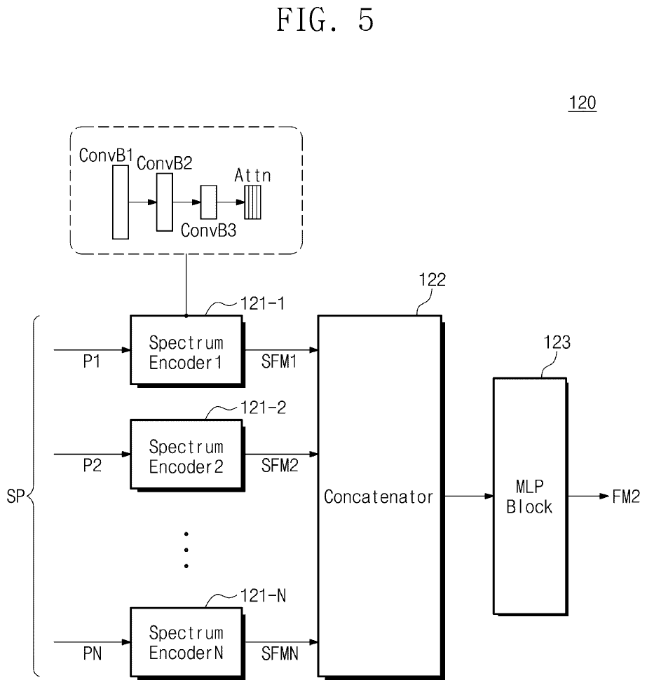

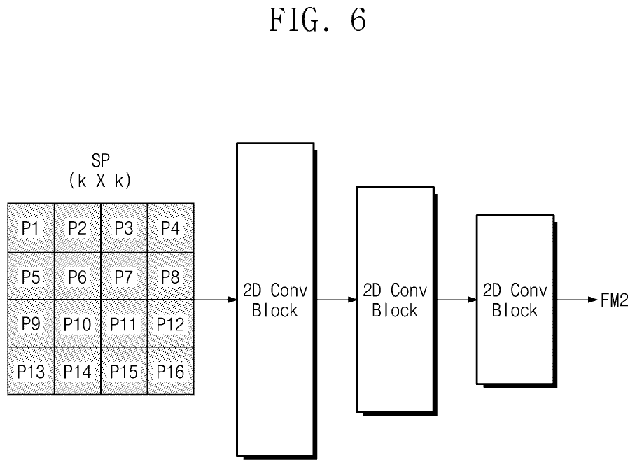

At least one of the convolutional layers ConvB1 to ConvB3 used by the above-described spectrum encoder may be included in the second encoder 120 of FIG. 2. This will be more fully described with reference to FIGS. 5 and 6.

FIG. 5 is a block diagram illustrating in detail an example of the second encoder 120 of FIG. 2. Referring to FIG. 5, the second encoder 120 may include a plurality of spectrum encoders 121-1 to 121-N, a concatenator 122, and a MLP block 123. The spectrum data SP and the second feature map FM2 of FIG. 5 may correspond to the spectrum data SP and the second feature map FM2 of FIG. 2, respectively.

The spectrum data SP may include a plurality of sub-spectrums P1 to PN. The plurality of sub-spectrums P1 to PN may correspond to pieces of incident light with respect to a target object. The pieces of incident light may have different incident angles to the target object.

For example, the spectrum data SP may include the first sub-spectrum P1. The first sub-spectrum P1 may correspond to the first incident light having a first incident angle to the target object. Furthermore, the spectrum data SP may include the second sub-spectrum P2. The second sub-spectrum P2 may correspond to the second incident light having a second incident angle to the target object.

Each of the plurality of spectrum encoders 121-1 to 121-N may include the plurality of convolutional layers ConvB1 to ConvB3 and the attention layer Attn. In this case, the plurality of convolutional layers ConvB1 to ConvB3 and the attention layer Attn may correspond to the plurality of convolutional layers ConvB1 to ConvB3 and the attention layer Attn of the SPENDER architecture of FIG. 4, respectively.

In detail, the first spectrum encoder 121-1 may generate a first sub-feature map SFM1 by sequentially passing the first sub-spectrum P1 through the plurality of convolutional layers ConvB1 to ConvB3 and the attention layer Attn. The first spectrum encoder 121-1 may provide the first sub-feature map SFM1 to the concatenator 122.

The second spectrum encoder 121-2 may generate a second sub-feature map SFM2 by sequentially passing the second sub-spectrum P2 through the plurality of convolutional layers ConvB1 to ConvB3 and the attention layer Attn. The second spectrum encoder 121-2 may provide the second sub-feature map SFM2 to the concatenator 122.

The N-th spectrum encoder 121-N may generate an N-th sub-feature map SFMN by sequentially passing the N-th sub-spectrum PN through the plurality of convolutional layers ConvB1 to ConvB3 and the attention layer Attn. The N-th spectrum encoder 121-N may provide the N-th sub-feature map SFMN to the concatenator 122.

Although not shown, the third to (N−1)-th spectrum encoders may respectively generate third to (N−1)-th sub-feature maps based on third to (N−1)-th sub-spectrums in a similar method to a method described above and may provide the third to (N−1)-th sub-feature maps to the concatenator 122.

The concatenator 122 may receive the first to N-th sub-feature maps SFM1 to SFMN from the first to N-th spectrum encoders 121-1 to 121-N, respectively. The concatenator 122 may concatenate the first to N-th sub-feature maps SFM1 to SFMN. The concatenator 122 may generate the second feature map FM2 by passing the concatenated first to N-th sub-feature maps SFM1 to SFMN to the MLP block 123. In this case, the MLP block 123 may include the MLP of FIG. 4.

FIG. 6 is a block diagram illustrating in detail an example of the second encoder 120 of FIG. 2. Referring to FIG. 6, an operation of generating the second feature map FM2 based on the spectrum data SP is specifically described.

The spectrum data SP may include the plurality of sub-spectrums P1 to PN as described in FIG. 5. In detail, the spectrum data SP may include the plurality of sub-spectrums P1 to PN synthesized in ‘k’ rows and ‘k’ columns. Here, ‘k’ is a natural number greater than 2, and ‘N’ is equal to k².

The second encoder may generate the second feature map FM2 based on applying at least one 2D convolution operation to the spectrum data SP.

In some implementations, the second encoder may further include an MLP block, similarly to FIG. 5.

In some implementations, the second encoder may further include an attention layer between 2D convolutional layers, similarly to FIG. 4.

FIG. 7 is a drawing for describing an example of the feature vector generator 130 of FIG. 2. Referring to FIG. 7, the feature vector generator 130 may include a first convertor 131, a second convertor 132, and a deep learning model 133. The first convertor 131, the second convertor 132, and the deep learning model 133 of FIG. 7 may correspond to the first convertor, the second convertor, and the deep learning model of FIG. 2, respectively.

The first convertor 131 may receive the first feature map FM1 from the first encoder 110 of FIG. 2 and may convert the first feature map FM1 into an n-th image vector Zn.

In some implementations, the first convertor 131 may generate the n-th image vector Zn by applying a 2D convolution operation to the first feature map FM1. The n-th image vector Zn may include noise.

The second convertor 132 may receive the second feature map FM2 from the second encoder 120 of FIG. 2 and may convert the second feature map FM2 into a plurality of spectrum vectors.

The deep learning model 133 may output the feature vector FV corresponding to the 3D structure of the target object in FIG. 1 based on the n-th image vector Zn and the plurality of spectrum vectors.

In some implementations, the deep learning model 133 may be a neural network model machine-learned by data sets including a feature map obtained from 2D image data, a feature map obtained from spectrum data, and 3D image data of a target object.

The deep learning model 133 may be an autoencoder-based model. The deep learning model 133 may include an encoder and a decoder.

For example, in encoding, the deep learning model 133 may sequentially apply first to fourth encoding layers E1 to E4 to the input n-th image vector Zn. Each of the first to fourth encoding layers E1 to E4 may perform cross attention between one of the plurality of spectrum vectors and the n-th image vector Zn (or the n-th image vector Zn to which the encoding layer is applied). For example, a spectrum vector having a size suitable for performing cross attention among a plurality of spectrum vectors may be used in each of encoding layers.

In decoding, the deep learning model 133 may sequentially apply first to third decoding layers D1 to D3 to low-dimensional data compressed by the first to fourth encoding layers E1 to E4. Each of the first to third decoding layers D1 to D3 may perform cross attention between one of the plurality of spectrum vectors and the n-th image vector Zn (e.g., the n-th image vector Zn to which the decoding layer is applied). For example, a spectrum vector having a size suitable for performing cross attention among the plurality of spectrum vectors may be used in each of the decoding layers.

The cross attention may indicate a technique for training the correlation between spectrum data and an image vector corresponding to the target object. The cross attention may generate a vector including information about a bias ‘B’ and a weight ‘W’ corresponding to the correlation.

For example, among features to be extracted through a feature map, a greater weight is assigned to a part to be focused. Alternatively, the bias may be adjusted to focus on the part to be focused. In some implementations, each of the first to fourth encoding layers E1 to E4 may include a convolutional layer performing at least one convolution operation. Data passing through the convolutional layer is provided to one of the first to third decoding layers D1 to D3, provided to a pooling layer to be down-sampled, and then provided to the next encoding layer.

For example, data passing through a convolution layer in the first encoding layer E1 is provided to the third decoding layer D3, also provided to the pooling layer to be down-sampled, and then provided as input data of the second encoding layer E2. Data passing through the convolutional layer in the second encoding layer E2 is provided to the second decoding layer D2, also provided to the pooling layer to be down-sampled, and then provided as input data to the third encoding layer E3. Data passing through the convolutional layer in the third encoding layer E3 may be provided to the first decoding layer D1, may be also provided to the pooling layer to be down-sampled, and then may be provided as input data to the fourth encoding layer E4. However, data passing through the convolution layer in the fourth encoding layer E4 may be provided to the pooling layer, may be down-sampled, and then may be provided to the first decoding layer D1.

Each of the first to third decoding layers D1 to D3 may concatenate data received from the previous decoding layer and data received from the corresponding encoding layer and then may use the concatenated data as input data of decoding. In other words, the deep learning model 133 may use not only low-dimensional information but also high-dimensional information. Each of the first to third decoding layers D1 to D3 may perform at least one inverse convolution operation on input data. In other words, each of the first to third decoding layers D1 to D3 may include at least one inverse convolutional layer.

In some implementations, each of the first to third decoding layers D1 to D3 may also include a convolutional layer. For example, each of the first to third decoding layers D1 to D3 may reduce the number of channels by half by passing data passing through the inverse convolutional layer to the convolutional layer.

The first decoding layer D1 may concatenate data received from the fourth encoding layer E4 and data received from the third encoding layer E3 and then may use the concatenated data as input data. The second decoding layer D2 may concatenate data passing through the convolution layer of the first decoding layer D1 and data received from the second encoding layer E2 and then may use the concatenated data as the input data. The third decoding layer D3 may concatenate data passing through the convolutional layer of the second decoding layer D2 and data received from the first encoding layer E1 and then may use the concatenated data as the input data. The third decoding layer D3 may output a (n−1)-th image vector Zn−1 by passing the input data through at least one inverse convolutional layer and at least one convolutional layer.

For example, the (n−1)-th image vector Zn−1 may include noise. However, the noise of the (n−1)-th image vector Zn−1 may be smaller than the noise of the n-th image vector Zn.

The deep learning model 133 may perform the above-described process once more by using the (n−1)-th image vector Zn−1 as the input data. For example, the deep learning model 133 may generate a (n−2)-th image vector based on cross attention between the (n−1)-th image vector Zn−1 and the plurality of spectrum vectors. In this way, the deep learning model 133 may generate an image vector, in which noise is gradually removed, by repeating the above-described process.

The deep learning model 133 may output a first image vector z1 as the feature vector FV to the decoder 140 by repeating the above-described process the predetermined number of times ‘t’. At this time, ‘t’ may be equal to (N−1).

In some implementations, the deep learning model 133 may be a denoising U-Net.

FIG. 8 is a block diagram illustrating an example of the decoder 140 of FIG. 2. Referring to FIG. 8, the decoder 140 may include a depth map generator 141 and a 3D image data generator 142. The feature vector FV and 3D image data of FIG. 8 may correspond to the feature vector FV and 3D image data of FIG. 2, respectively.

The depth map generator 141 may receive the feature vector FV. The depth map generator 141 may generate a depth map DM based on the feature vector FV. In detail, the depth map generator 141 may predict the 3D structure of the target object in FIG. 2 based on the feature vector FV. The depth map generator 141 may generate the depth map DM based on the predicted 3D structure.

In the model corresponding to the 3D structure prediction device 100 of FIG. 2, the first encoder 110, the second encoder 120, and the feature vector generator 130 may correspond to an encoder of the entire model; the feature vector FV may correspond to the encoding result; and the depth map generator 141 may correspond to a decoder of the entire model.

In other words, the depth map generator 141 may be a model machine-learned on large data sets (e.g., including 2D image data, spectrum data, and 3D structure of the target object).

The depth map DM may have the format of 2D image data obtained when viewed from above the target object. The depth map DM may be displayed darker as it gets deeper, and may be displayed brighter as it gets shallower. The depth map generator 141 may provide the depth map DM to the 3D image data generator 142.

The 3D image data generator 142 may receive the depth map DM from the depth map generator 141. The 3D image data generator 142 may generate output image data OIM corresponding to the target object based on the depth map DM. The output image data OIM may indicate the 3D structure of the target object.

In some implementations, the output image data OIM may have a 3D image data format.

In some implementations, the output image data OIM may have a point cloud format. However, the scope of the present disclosure is not limited thereto. The 3D image data generator 142 may generate 3D image data in various ways capable of expressing the 3D structure of the target object.

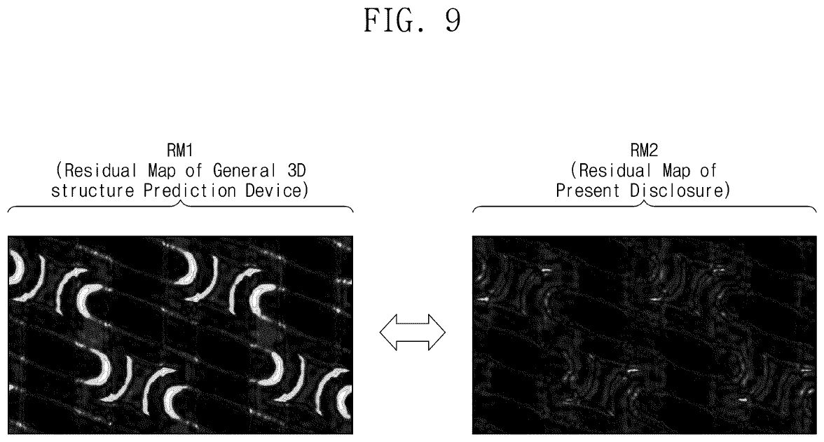

FIG. 9 is a diagram for describing an example of a residual map based on a general depth map and a depth map generated. Referring to FIG. 9, a first residual map RM1 associated with a general depth map generated by a general 3D structure prediction device, and a second residual map RM2 associated with a depth map generated by a 3D structure prediction device according to implementations of the present disclosure are illustrated.

The residual map may be image data indicating a difference between two pieces of image data. For example, the residual map may map two image data and may be displayed in brighter color as the difference is greater. On the other hand, the residual map may be displayed in darker color as the difference is smaller.

The first residual map RM1 may be generated based on the difference between a general depth map and a raw depth map generated based on the 3D structure of the actual target object.

The second residual map RM2 may be generated based on the difference between the depth map generated by the 3D structure prediction device of the present disclosure and the raw depth map.

As shown, the first residual map RM1 has more areas displayed in bright colors than the second residual map RM2. In other words, the difference between the depth map and the raw depth map may be smaller than the difference between the general depth map and the raw depth map. The depth map may be closer to the raw depth map than the general depth map.

In other words, the 3D structure prediction device may predict the 3D structure of the target object more accurately than the general 3D structure prediction device. Accordingly, when a system equipped with the 3D structure prediction device is used to evaluate a semiconductor manufacturing process, various types of defects may be detected, thereby increasing yield and reducing development costs.

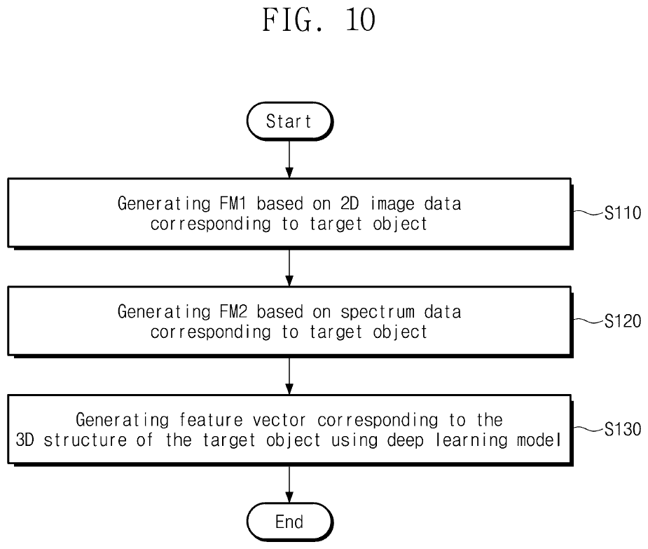

FIG. 10 is a flowchart for sequentially describing an example of a method of operating the 3D structure prediction device 100 of FIG. 2. Referring to FIG. 10, a method of operating a 3D structure prediction device will be described.

The 3D structure prediction device may include a first encoder, a second encoder, and a feature vector generator. The first encoder, the second encoder, and the feature vector generator may correspond to the first encoder 110, the second encoder 120, and the feature vector generator 130 of FIG. 2, respectively.

In operation S110, the 3D structure prediction device may generate the first feature map FM1 based on 2D image data corresponding to a target object by the first encoder.

In some implementations, the first encoder may include the encoder of a GAN including a 2D convolution operation.

In some implementations, the first encoder may include an encoder of VQGAN architecture.

In some implementations, 2D image data may be obtained by at least one of SEM, X-ray, AFM, and TEM.

In operation S120, the 3D structure prediction device may generate the second feature map FM2 based on spectrum data corresponding to the target object by the second encoder.

In some implementations, the spectrum data may include a first sub-spectrum and a second sub-spectrum.

In some implementations, operation S120 may include generating a first sub-feature map by applying at least one convolution operation to the first sub-spectrum, generating a second sub-feature map by applying at least one convolution operation to the second sub-spectrum, and generating the second feature map FM2 by concatenating the first sub-feature map and the second sub-feature map.

In some implementations, the spectrum data may be obtained based on an optical critical dimension (OCD) measurement method.

In operation S130, the 3D structure prediction device may output a feature vector corresponding to the 3D structure of the target object by using a deep learning algorithm by the feature vector generator.

In some implementations, the deep learning algorithms may include a denoising algorithm.

In some implementations, the deep learning algorithm may be denoising Unet.

In some implementations, operation S130 may include converting the first feature map FM1 into an n-th image vector, converting the second feature map FM2 into a plurality of spectrum vectors, and generating a feature vector based on cross attention between the n-th image vector and the plurality of spectrum vectors.

As a specific example, the generating of the feature vector based on the cross attention between the n-th image vector and the plurality of spectrum vectors may include generating an (n−1)-th image vector by performing cross attention between the n-th image vector and the plurality of spectrum vectors, and generating the feature vector based on cross attention between the (n−1)-th image vector and the plurality of spectrum vectors.

In some implementations, the 3D structure prediction device may further include generating output image data indicating the 3D structure of the target object by decoding the feature vector.

The above description refers to detailed implementations for carrying out the present disclosure. The present disclosure may include implementations in which a design is changed simply or which are easily changed, as well as the implementations described above. In addition, technologies that are easily changed and implemented by using the above implementations may be included in the present disclosure. While the present disclosure has been described with reference to implementations described above, it will be apparent to those of ordinary skill in the art that various changes and modifications may be made thereto without departing from the spirit and scope of the present disclosure as set forth in the following claims.

In some implementations, a device for predicting 3D structure by using multiple signals and a method of operating the same are provided.

Moreover, the 3D structure of an element may be predicted more accurately, and various types of defect analysis may be performed, by simultaneously applying two-dimensional (2D) image data and spectrum data corresponding to depth information to a 3D structure prediction model. Accordingly, the yield may be improved and the cost may be reduced.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the present disclosure has been described with reference to implementations thereof, it will be apparent to those of ordinary skill in the art that various changes and modifications may be made thereto without departing from the spirit and scope of the present disclosure as set forth in the following claims.

What is claimed is:

1. A three-dimensional (3D) structure prediction device comprising:
a first encoder configured to generate a first feature map based on two-dimensional (2D) image data, the 2D image data corresponding to a target object;
a second encoder configured to generate a second feature map based on spectrum data, the spectrum data corresponding to the target object; and
a feature vector generator configured to
receive the first feature map and the second feature map, and
output a feature vector based on a deep machine learning model, the feature vector corresponding to a 3D structure of the target object.

2. The 3D structure prediction device of claim 1, comprising:
a decoder configured to generate output image data based on decoding the feature vector, the output image data indicating the 3D structure of the target object.

3. The 3D structure prediction device of claim 2, wherein the decoder includes:
a depth map generator configured to
receive the feature vector, and
generate a depth map based on decoding the feature vector; and
a 3D image generator configured to generate the output image data as 3D image data based on the depth map, the 3D image data corresponding to the 3D structure of the target object.

4. The 3D structure prediction device of claim 3, wherein the 3D image generator is configured to:
generate the output image data in a form of a point cloud.

5. The 3D structure prediction device of claim 1, wherein the feature vector generator is configured to:
generate an n-th image vector based on application of a diffusion algorithm to the first feature map;
generate a plurality of spectrum vectors based on conversion of a size of the first feature map; and
generate the feature vector based on cross attention between the n-th image vector and the plurality of spectrum vectors, and
wherein n is a natural number greater than or equal to 2.

6. The 3D structure prediction device of claim 5, wherein the feature vector generator is configured to:
generate an (n−1)-th image vector based on the cross attention between the n-th image vector and the plurality of spectrum vectors; and
generate the feature vector based on cross attention of the (n−1)-th image vector and the plurality of spectrum vectors.

7. The 3D structure prediction device of claim 5, wherein the feature vector generator is configured to use a denoising algorithm as the deep machine learning model.

8. The 3D structure prediction device of claim 7, wherein the denoising algorithm is denoising UNet.

9. The 3D structure prediction device of claim 5, wherein the feature vector generator is configured to:
generate the n-th image vector based on a convolution operation of the first feature map.

10. The 3D structure prediction device of claim 5, wherein the feature vector generator is configured to:
generate the plurality of spectrum vectors based on applying a multi-layer perceptron (MLP) algorithm to the second feature map.

11. The 3D structure prediction device of claim 1, wherein the first encoder includes an encoder of a generative adversarial network (GAN), the GAN including a 2D convolution operation.

12. The 3D structure prediction device of claim 11, wherein the GAN is a vector quantized generative adversarial network (VQGAN).

13. The 3D structure prediction device of claim 1, wherein the spectrum data includes a first sub-spectrum and a second sub-spectrum,
wherein the first sub-spectrum corresponds to first incident light having a first incident angle to the target object,
wherein the second sub-spectrum corresponds to second incident light having a second incident angle to the target object, and
wherein the second encoder is configured to:
generate a first sub-feature map based on a convolution operation of the first sub-spectrum;
generate a second sub-feature map based on a convolution operation of the second sub-spectrum; and
generate the second feature map based on concatenation of the first sub-feature map and the second sub-feature map.

14. The 3D structure prediction device of claim 13, wherein the second encoder is configured to use a convolution operation of SPENDER architecture as the convolution operation applied to the first sub-spectrum and the second sub-spectrum.

15. The 3D structure prediction device of claim 1, wherein the spectrum data includes n² sub-spectrums concatenated in n rows and n columns, and
wherein the second encoder is configured to:
generate the second feature map based on applying at least one 2D convolution operation to the n² sub-spectrums, n being a natural number greater than or equal to 2.

16. The 3D structure prediction device of claim 1, wherein the 2D image data is obtained based on at least one of a scanning electron microscope, X-ray, an atomic force microscope, or a transmission electron microscope.

17. The 3D structure prediction device of claim 1, wherein the spectrum data is obtained based on an optical critical dimension measurement method.

18. A method of operating a three-dimensional (3D) structure prediction device, the method comprising:
generating a first feature map based on two-dimensional (2D) image data, the 2D image data corresponding to a target object;
generating a second feature map based on spectrum data, the spectrum data corresponding to the target object;
generating a feature vector based on a deep machine learning model, the feature vector corresponding to a 3D structure of the target object; and
outputting the feature vector.

19. The method of claim 18, comprising:
generating output image data based on decoding the feature vector, the output image data indicating the 3D structure of the target object.

20. An electronic system that predicts a three-dimensional (3D) structure of a target object, the electronic system comprising:
a first sensor device configured to generate two-dimensional (2D) image data based on sensing the target object;
a second sensor device configured to generate spectrum data based on sensing the target object; and
a 3D structure prediction device configured to generate 3D image data based on the 2D image data and the spectrum data, the 3D image data corresponding to the 3D structure of the target object,
wherein the 3D structure prediction device includes:
a first encoder configured to generate a first feature map based on the 2D image data;
a second encoder configured to generate a second feature map based on the spectrum data; and
a feature vector generator configured to
receive the first feature map and the second feature map, and
output a feature vector based on a deep machine learning model, the feature vector corresponding to the 3D structure of the target object.
